(19) United States
(12) Patent Application Publication
(10) Pub. No.: US 2013/0266152 A1
(43) Pub. Date: Oct. 10, 2013

(54) SYNCHRONIZING WIRELESS EARPHONES

(71) Applicants: Joel L. Haynie, (US); Hytham Alihassan, (US); Timothy Wawrzynczak, (US)

(72) Inventors: Joel L. Haynie, (US); Hytham Alihassan, (US); Timothy Wawrzynczak, (US)

(73) Assignee: Koss Corporation, Milwaukee, WI (US)

(21) Appl. No.: 13/441,476

(22) Filed: Apr. 6, 2012

(51) Int. Cl. H04R 3/00; H04B 7/00

(52) U.S. Cl. 381/80

(57) ABSTRACT

Various embodiments are directed to systems and methods involving first and second acoustic speaker devices for synchronizing playback of a common audio playback signal by the first and second acoustic speaker devices. The first acoustic speaker device may transmit wirelessly a first message comprising a first checksum set comprising a plurality of checksums indicating units of the common audio playback signal in a playback queue of the first acoustic speaker device. The second acoustic speaker device may receive and compare the first checksum set to a second checksum set comprising a plurality of checksums indicating units of the common audio playback signal in a playback queue of the second acoustic speaker device. The presence or absence of a match between the first and second checksum sets, as well as an offset, if any, of the match may indicate which acoustic speaker device is behind and by how many units.

### BACKGROUND

Wireless earphones or headsets are known. For example, PCT application PCT/US09/39754, which is incorporated herein by reference in its entirety, discloses a wireless earphone that receives and plays streaming digital audio. When a user wears wireless earphones in both of his/her ears, the playing of the digital audio stream preferably is synchronized to reduce or eliminate the Haas effect. The Haas effect is a psychoacoustic effect related to a group of auditory phenomena known as the Precedence Effect or law of the first wave front. These effects, in conjunction with sensory reaction(s) to other physical differences (such as phase differences) between perceived sounds, are responsible for the ability of listeners with two ears to localize accurately sounds coming from around them. When two identical sounds (e.g., identical sound waves of the same perceived intensity) originate from two sources at different distances from the listener, the sound created at the closest location is heard (arrives) first. To the listener, this creates the impression that the sound comes from that location alone due to a phenomenon that may be described as “involuntary sensory inhibition” in that one's perception of later arrivals is suppressed. The Haas effect can occur when arrival times of the sounds differ by as little as 5 milliseconds. As the arrival time (in respect to the listener) of the two audio sources increasingly differ, the sounds will begin to be heard as distinct. This is not a desirous effect when listening to audio in a pair of earphones.

### SUMMARY

In one general aspect, the present invention is directed to systems and methods involving first and second acoustic speaker devices, such as earphones, for synchronizing playback of a common audio playback signal. The first acoustic speaker device may wirelessly transmit to the second acoustic speaker device a first message comprising a first checksum set. The first checksum set may comprise a plurality of checksums indicating units of the common audio playback signal in a playback queue of the first acoustic speaker device. The second acoustic speaker device compares the first checksum set to a second checksum set comprising a plurality of checksums indicating units of the common audio playback signal in a playback queue of the second acoustic speaker device. The presence or absence of a match between the first and second checksum sets, as well as an offset, if any, of the match indicates which acoustic speaker device is behind and by how many units. The acoustic speaker device that is behind may “catch-up” by dropping a number of units equivalent to the offset. Where there is no match between the checksum sets, an extended synchronization mode may be used, as described herein, to identify and correct offset synchronization.

### FIGURES

Various embodiments of the present invention are described herein by way of example in connection with the following figures, wherein:

FIG. 1 illustrates a pair of wireless earphone according to various embodiments of the present invention.

FIG. 2 is a block diagram of a wireless earphone according to various embodiments of the present invention.

FIG. 3 is a flow chart showing an example process flow, according to various embodiments, for converting received audio data to sound utilizing one of the earphones of FIG. 1.

FIG. 4 is a flow chart showing an example process flow, according to various embodiments, for synchronizing the system clocks of the earphones of FIG. 1.

FIG. 5 is a state diagram showing an example state flow, according to various embodiments, for synchronizing the system clocks of the earphones of FIG. 1.

FIG. 6 is a flow chart showing an example process flow, according to various embodiments, for synchronizing audio data playback.

FIGS. 7A and 7B are block diagrams showing comparisons between example master checksum sets and example slave checksum sets, according to various embodiments.

FIG. 8 is a flow chart showing an example process flow, according to various embodiments, for implementing the extended synchronization mode of the process flow of FIG. 6.

FIG. 9 is a bounce diagram showing synchronization of the earphones in an example situation where the slave earphone is behind the master earphone, but by a number of units small enough to avoid the extended synchronization mode of the process flow of FIG. 8.

FIG. 10 is a bounce diagram showing synchronization of the earphones in an example situation where the master earphone is behind the slave earphone, but by a number of units small enough to avoid the extended synchronization mode.

FIG. 11 is a bounce diagram showing synchronization of the earphones in an example situation where the slave is behind by a number of units large enough to implicate the extended synchronization mode.

FIG. 12 is a bounce diagram showing synchronization of the earphones in an example situation where the master earphone is behind by a number of units large enough to implicate the extended synchronization mode.

FIG. 13 is a bounce diagram showing synchronization of the earphones in an example embodiment where the slave earphone is behind by a number of units large enough to implicate the extended synchronization mode, but where both earphones find the other's synchronization marker.

FIG. 14 is a bounce diagram showing synchronization of the earphones in another example embodiment where the master earphone is behind by a number of units large enough to implicate the extended synchronization mode, but where both earphones find the other's synchronization marker.

FIG. 15 is a state diagram showing an example state flow, according to various embodiments, for synchronizing a playback (e.g., according to the process flows of FIGS. 6 and 8 and incorporating concepts from the example bounce diagrams of FIGS. 9-14).

### DESCRIPTION

Various embodiments of the present invention are directed to electroacoustical speaker devices that exchange synchronization data so that the speaker devices synchronously play audio received from a source. Various embodiments of the present invention are described herein with reference to wireless earphones as the speaker devices, although it should be recognized that the invention is not so limited and that different types of speakers besides earphones could be used in other embodiments. In addition, the earphones (or other types of speakers) do not need to be wireless.

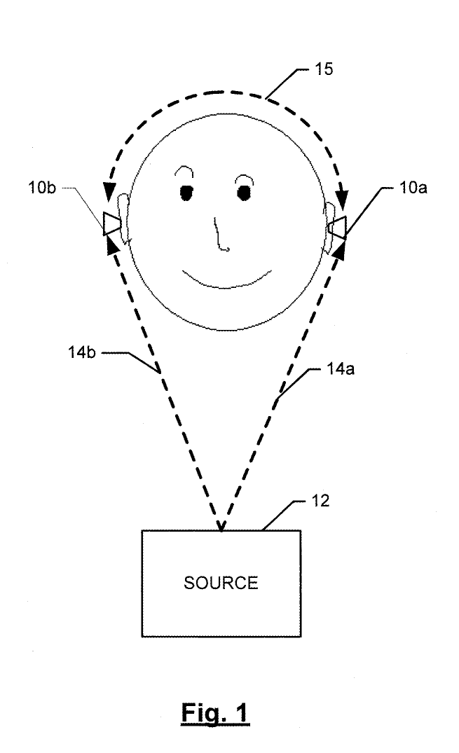

FIG. 1 is a diagram of a user wearing two wireless earphones 10a, 10b—one in each ear. As described herein, the earphones 10a, 10b may receive and synchronously play digital audio data, such as streaming or non-streaming digital audio. The earphones 10a, 10b may receive digital audio data from a digital audio source via respective communication links 14a, 14b. The communication links 14a, 14b may be wireless or wired communication links. The earphones 10a, 10b may exchange synchronization data (e.g., clock and audio synchronization data) via a wireless communication link 15. The two earphones 10a, 10b may play the audio nearly synchronously for the user, e.g., preferably with a difference in arrival times between the two earphones small enough that the Haas effect is not observed (e.g., between five (5) milliseconds or less and about forty (40) milliseconds or less). Herein, some processing is described as being performed by a slave earphone 10b, while other processing is described as being performed by a master earphone 10a. It will be appreciated that, depending on the embodiment and unless otherwise indicated, any of the processing described herein as being performed by the master 10a may also be performed by the slave 10b in addition to or instead of by the master 10a and any processing described as being performed by the slave 10b may be performed by the master 10a in addition to or instead of by the slave 10b.

In various embodiments, as described in PCT application PCT/US09/39754, which is incorporated herein by reference in its entirety, the source 12 may be a digital audio player (DAP), such as an mp3 player or an iPod, or any other suitable source of digital audio, such as a laptop or a personal computer, that stores and/or plays digital audio files, and that communicates with the earphones 10a, 10b via the data communication links 14a, 14b. For embodiments where one or more of the data communication links 14a, 14b are wireless, any suitable wireless communication protocol may be used. Preferably, the wireless links 14a, 14b are Wi-Fi (e.g., IEEE 802.11a/b/g/n) communication links, although in other embodiments different wireless communication protocols may be used, such as WiMAX (IEEE 802.16), Bluetooth, Zigbee, UWB, etc. For embodiments where one or more of the data communication links 14a, 14b are wired links, any suitable communication protocol may be used, such as Ethernet. Also, the source 12 may be a remote server, such as a (streaming or non-streaming) digital audio content server connected on the Internet, that connects to the earphones 10a, 10b, such as via an access point of a wireless network or via a wired connection. For embodiments where one or more of the data communication links 14a, 14b are wireless, the wireless communication link 15 between the master earphone 10a and the slave earphone 10b may use the same network protocol as the wireless communication link or links 14a, 14b.

The synchronization methods and systems described herein may be applied to any suitable earphones or other acoustic speaker devices of any shape and/or style. In some example embodiments, the shape and style of the earphones may be as described in the following published patent applications, all of which are incorporated herein by reference in their entirety: U.S. Patent Application Publication No. 2011/0103609; U.S. Patent Application Publication No. 2011/0103636; and WO 2009/086555. Of course, in other embodiments, different earphone styles and shapes may be used.

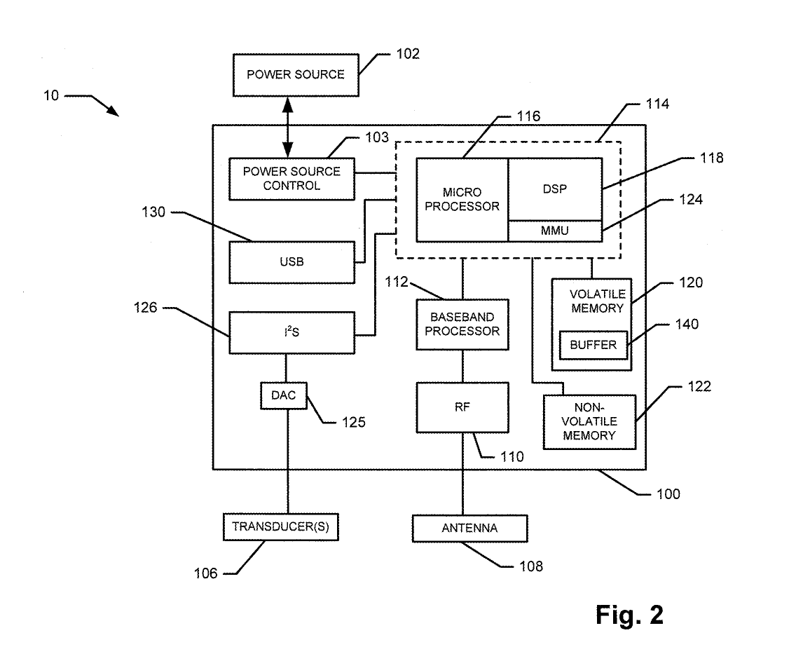

FIG. 2 is a block diagram of one of the earphones 10a, 10b according to various embodiments of the present invention. In various embodiments, the components of the earphones 10a, 10b may be the same. In the illustrated embodiment, the earphone 10 comprises a transceiver circuit 100 and related peripheral components. The peripheral components of the earphone 10 may comprise a power source 102, one or more acoustic transducers 106 (e.g., speakers), and one or more antennas 108. The transceiver circuit 100 and some of the peripheral components (such as the power source 102 and the acoustic transducers 106) may be housed within a body of the earphone 10. In other embodiments, the earphone may comprise additional peripheral components, such as a microphone, for example.

In various embodiments, the transceiver circuit 100 may be implemented as a single integrated circuit (IC), such as a system-on-chip (SoC), which is conducive to miniaturizing the components of the earphone 10, which is advantageous if the earphone 10 is to be relatively small in size, such as an in-ear earphone. In alternative embodiments, however, the components of the transceiver circuit 100 could be realized with two or more discrete ICs, such as separate ICs for the processors, memory, and Wi-Fi module, for example. For example, one or more of the discrete IC's making up the transceiver circuit 100 may be off-the-shelf components sold separately or as a chip set.

The power source 102 may comprise, for example, a rechargeable or non-rechargeable battery (or batteries). In other embodiments, the power source 102 may comprise one or more ultracapacitors (sometimes referred to as supercapacitors) that are charged by a primary power source. In embodiments where the power source 102 comprises a rechargeable battery cell or an ultracapacitor, the battery cell or ultracapacitor, as the case may be, may be charged for use, for example, when the earphone 10 is connected to a docking station, in either a wired or wireless connection. The docking station may be connected to or part of a computer device, such as a laptop computer or PC. In addition to charging the rechargeable power source 102, the docking station may facilitate downloading of data to and/or from the earphone 10. For example, the docking station may facilitate the downloading and uploading to and from the earphone 10 of configuration data, such as data describing a role of the earphone 10 (e.g., master or slave as described herein). In other embodiments, the power source 102 may comprise capacitors passively charged with RF radiation, such as described in U.S. Pat. No. 7,027,311. The power source 102 may be coupled to a power source control module 103 of the transceiver circuit 100 that controls and monitors the power source 102.

The acoustic transducer(s) 106 may be the speaker element(s) for conveying the sound to the user of the earphone 10. According to various embodiments, the earphone 10 may comprise one or more acoustic transducers 106. For embodiments having more than one transducer, one transducer may be larger than the other transducer, and a crossover circuit (not shown) may transmit the higher frequencies to the smaller transducer and may transmit the lower frequencies to the larger transducer. More details regarding dual element earphones are provided in U.S. Pat. No. 5,333,206, assigned to Koss Corporation, which is incorporated herein by reference in its entirety.

The antenna 108 may receive the wireless signals from the source 12 via the communication link 14a or 14b. The antenna 108 may also radiate signals to and/or receive signals from the opposite earphone 10a, 10b (e.g., synchronization signals) via the wireless communication link 15. In other embodiments, separate antennas may be used for the different communication links 14a, 14b, 15.

For embodiments where one or more of the communication links 14a, 14b, 15 are wireless links, an RF module 110 of the transceiver circuit 100 in communication with the antenna 108 may, among other things, modulate and demodulate the signals transmitted from and received by the antenna 108. The RF module 110 communicates with a baseband processor 112, which performs other functions necessary for the earphone 10 to communicate using the Wi-Fi (or other communication) protocol. In various embodiments, the RF module 110 may be and/or comprise an off-the-shelf hardware component available from any suitable manufacturer such as, for example, MICROCHIP, NANORADIO, H&D WIRELESS, TEXAS INSTRUMENTS, INC., etc.

The baseband processor 112 may be in communication with a processor unit 114, which may comprise a microprocessor 116 and a digital signal processor (DSP) 118. The microprocessor 116 may control the various components of the transceiver circuit 100. The DSP 118 may, for example, perform various sound quality enhancements to the digital audio signal received by the baseband processor 112, including noise cancellation and sound equalization. The processor unit 114 may be in communication with a volatile memory unit 120 and a non-volatile memory unit 122. A memory management unit 124 may control the processor unit's access to the memory units 120, 122. The volatile memory 120 may comprise, for example, a random access memory (RAM) circuit. The non-volatile memory unit 122 may comprise a read only memory (ROM) and/or flash memory circuits. The memory units 120, 122 may store firmware that is executed by the processor unit 114. Execution of the firmware by the processor unit 114 may provide various functionalities for the earphone 10, including those described herein, including synchronizing the playback of the audio between the pair of earphones.

A digital-to-analog converter (DAC) 125 may convert the digital audio signals from the processor unit 114 to analog form for coupling to the acoustic transducer(s) 106. An I²S interface 126 or other suitable serial or parallel bus interface may provide the interface between the processor unit 114 and the DAC 125. Various digital components of the transceiver circuit 100 may receive a clock signal from an oscillator circuit 111, which may include, for example, a crystal or other suitable oscillator. Clock signals received from the oscillator circuit 111 may be used to maintain a system clock. For example, the processor unit 114 may increment a clock counter upon the receipt of each clock signal from the oscillator circuit 111.

The transceiver circuit 100 also may comprise a USB or other suitable interface 130 that allows the earphone 10 to be connected to an external device via a USB cable or other suitable link. In various embodiments, the functionality of various components including, for example, the microprocessor 116, the DSP 118, the baseband processor 112, the DAC 125, etc., may be combined in a single component for the processor unit 114 such as, for example, the AS 3536 MOBILE ENTERTAINMENT IC available from AUSTRIAMICROSYSTEMS. Also, optionally, one or more of the components of the transceiver circuit 100 may be omitted. For example, the functionalities of the microprocessor 116 and DSP 118 may be performed by a single processor. In various embodiments, the transceiver circuit 100 may implement a digital audio decoder. The decoder decodes received digital audio from a compressed format to a format suitable for analog conversion by the DAC 125. The compressed format may be any suitable compressed audio format including, for example, MPEG-1 or MPEG-2, audio layer III. The format suitable for analog conversion may be any format including, for example, pulse code modulated (PCM) format. The digital audio decoder may be a distinct hardware block (e.g., in a separate chip or in a common chip with the processor unit). In some embodiments, the digital audio decoder may be a software unit executed by the microprocessor 116, the DSP 118 or both. In some embodiments, the decoder is included as a hardware component, such as the decoder hardware component licensed from WIPRO and included with the AS 3536 MOBILE ENTERTAINMENT IC.

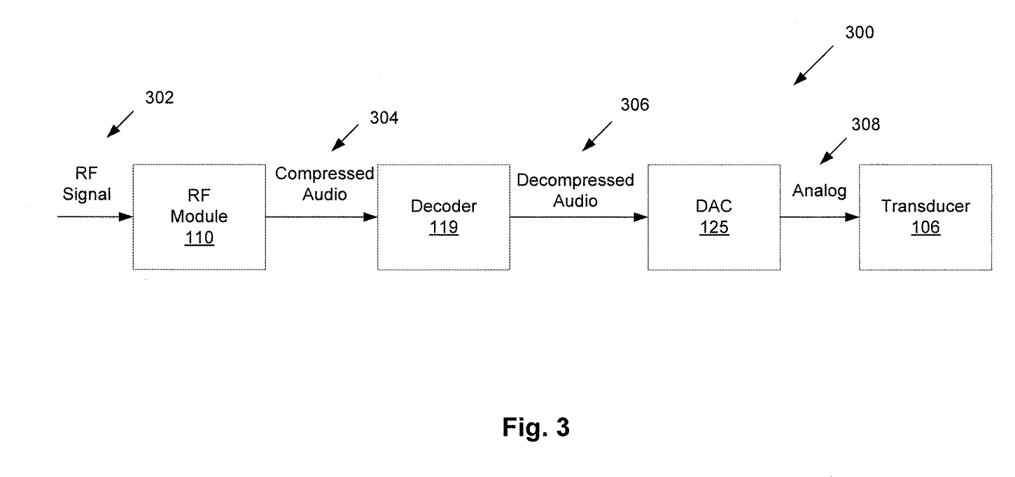

FIG. 3 is a flow chart showing an example process flow for converting received audio data to sound utilizing the earphone 10. The audio data may be received in an RF format, such as, for example, a Wi-Fi format. The received audio data may be streamed and/or non-streamed. The audio data may be received by the earphone 10 via communication channel 14 as an RF signal in any suitable format (e.g., in Wi-Fi format). The RF module 110 (e.g., in conjunction with the baseband processor 112) may demodulate the RF signal to a baseband compressed digital audio signal 304. In some embodiments, the RF module 110 also decodes the RF signal to remove protocol-oriented features including protocol wrappers such as, for example, Wi-Fi wrappers, Ethernet wrappers, etc. For example, the audio signal 304 may have been compressed at the source 12 or other compression location according to any suitable compression format including, for example, MPEG-1 or MPEG-2 audio layer III. In various embodiments, the compression format may be expressed as a series of frames, with each frame corresponding to a number of samples (e.g., samples of an analog signal) and each sample corresponding to a duration (e.g., determined by the sampling rate). For example, an MPEG-1, audio layer III frame sampled at about 44 kHz may correspond to 1,152 samples and 26 milliseconds (ms), though any suitable frame size and/or duration may be used. In addition to audio data (e.g., the samples), each frame may include header data describing various features of the frame. The header data may include, for example, a bit rate of the compression, synchronization data relating the frame to other frames in the audio file, a time stamp, etc. Audio organized according to a frame format may comprise encoded as well as non-encoded streams and files.

The compressed digital audio 304 may be provided to the decoder 305. The decoder 305 may decode the compressed audio signal 304 to form a decompressed audio signal 306. The decompressed audio signal 306 may be expressed in a format suitable for digital-to-analog conversion (e.g., PCM format). In various embodiments, the decompressed audio signal 306 may also have a frame format. For example, the decompressed audio signal 306 may be divided into frames, with each frame representing a set number of samples or duration. Frames in the decompressed signal may or may not have frame headers. For example, in some embodiments, the frame format of the decompressed audio signal 306 may be tracked by the processing unit 114. For example, the processing unit may count samples or other digital units of the decompressed audio signal 306 as they are provided to the DAC 125. A predetermined number of samples may correspond to the size of the decompressed audio frames either in number of samples, duration, or both. Upon receiving the decompressed audio signal 306 (e.g. via the I²S interface 126), the DAC 125 may generate an analog signal 308, that may be provided to the transducer 106 to generate sound. It will be appreciated that various amplification and filtering of the analog signal 308 may be performed in some embodiments prior to its conversion to sound by the transducer 106.

According to various embodiments, each earphone 10a, 10b may separately receive and play a common audio playback signal received from the source 12, for example, as described by the process flow 300. To achieve synchronized playback, the earphones 10a, 10b may synchronize their respective system clocks and/or directly synchronize audio playback. Synchronizing system clocks between the earphones 10a, 10b may involve correcting for any difference and/or drift between the respective system clocks. For example, the earphone 10a or 10b determined to have a faster system clock may drop one or more system clocks ticks. Synchronizing audio playback may involve attempting to calibrate playback of the audio data such that each earphone 10a, 10b is playing the same unit of the audio (e.g., frame, sample, etc.) at approximately the same time, or preferably, within 5-40 milliseconds of each other. For example, the earphone 10a or 10b determined to be behind may drop one or more units of the audio data in order to catch up. Units may be dropped at any suitable stage of the playback process, as illustrated by FIG. 3 including, for example, as compressed audio 304, decompressed audio 306 (e.g., PCM data), or analog audio 308. In various embodiments, one of the earphones 10a may act as a master for synchronization purposes, while the other 10b may act as a slave. The master 10a may initiate synchronization communications between the earphones 10a, 10b, for example, as described herein, for clock synchronization and/or audio playback synchronization. In some embodiments, one earphone may be a master 10a for clock synchronization while the other may be a master for audio playback synchronization.

The earphones 10a, 10b may achieve synchronized playback of digital audio data by synchronizing their internal or system clocks and using the synchronized clocks to commence playback at a common scheduled time. If playback is started at the same time the earphones 10a, 10b will stay in synchronization because their internal clocks are kept synchronized for the duration of the playback. For the purposes of synchronizing digital audio playback, the clocks may be considered synchronized if the time difference between them is less than 30 ms but preferably less than 500 micro seconds (μs). In some embodiments, it is desirable for the time difference to be 100 μs or lower. For example, in some embodiments, the time difference target may be 10 μs or less.

Clock synchronization may be achieved by the use of a digital or analog “heartbeat” radio pulse or signal, which is to be broadcast at a frequency higher than the desired time difference between the two clocks (preferably by an order of magnitude)—by an external source or by one of the earphones. In one example embodiment the heartbeat signal may be transmitted by the same radio module 110 used to transmit audio data between the earphones, but in other embodiments each earphone may comprise a second radio module—one for the heartbeat signal and one for the digital audio. The radio module for the heartbeat signal preferably is a low-power consumption, low bandwidth radio module, and preferably is short range. In various embodiments, the master earphone 10a may send a heartbeat signal to the slave earphone 10b on the second radio channel provided by the second radio module (e.g., link 15), which is different from the Wi-Fi radio channel (e.g., channel 14a, 14b).

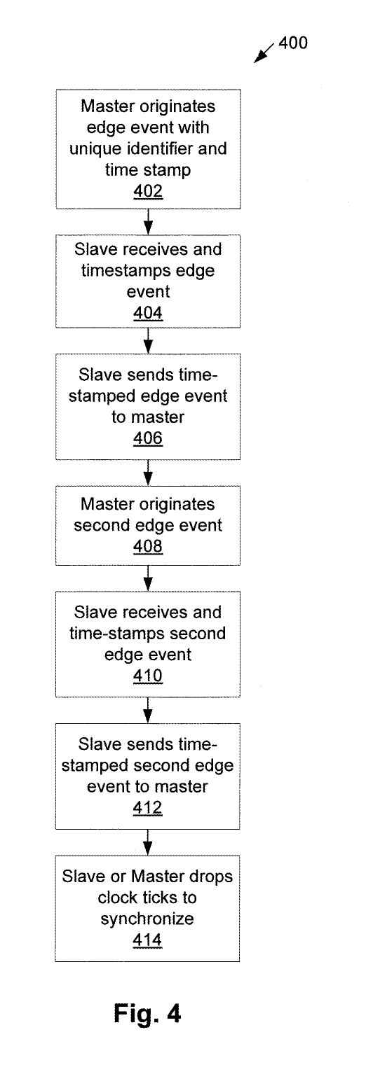

FIG. 4 is a flow chart showing an example process flow 400 for synchronizing the system clocks of the earphones 10a, 10b. At step 402, the master 10a may generate an edge event (e.g., based on its system clock) and transmit the edge event to the slave 10b (e.g., via communication link 15). In some embodiments, the edge event at 402 is generated by an actor other than the master 10a including, for example, a source or other third-party to the communication, the slave, etc. In various embodiments, however, only one actor in the communication generates edge events. At the time that the edge event is sent, the master 10a may generate and store a unique identifier for the edge event and a timestamp based on the master's system clock (e.g., a master timestamp). The timestamp may indicate the time at the occurrence of the edge event and/or the time that the edge event is transmitted to the slave 10b. The unique identifier of the edge event may be transmitted to the slave 10b. In some embodiments, however, the master timestamp is not transmitted and is kept in storage at the master 10a. At step 404, the slave 10b may receive the edge event, and timestamp its arrival based on the slave's own system clock (e.g., a slave timestamp).

The slave 10b may re-transmit the edge event, including the slave timestamp, to the master 10a at step 406. The master 10a and slave 10b may store a record of the edge event and the associated timestamps of the master and slave 10a, 10b. The difference, if any, between the master timestamp and the slave timestamp for the edge event is indicative of drift between the respective system clocks, as well as other factors such as jitter, propagation delay, etc. To cancel out any non-drift-related factors affecting the offset between the master and slave timestamps, a second edge event may be generated by the master 10a at step 408. The slave 10b may receive the second edge event and timestamp it at step 410. At step 412, the slave 10b may transmit the second edge event to the master at step 412.

It may be assumed that the propagation delay (e.g., the time it takes for the edge event to be transmitted from the master 10a to the slave 10b) is constant. Accordingly, when the respective system clocks are synchronized, the differences between the master and slave timestamps for successive edge events should be constant, subject to jitter. Drift in the timestamp difference among successive edge events may indicate drift in the respective system clocks 10a, 10b. Upon exchanging two or more edge events, as described herein, the master 10a and/or slave 10b may be able to calculate any drift that is present. To correct for drift, the earphone 10a or 10b having a faster system clock may drop clock ticks at step 414. To drop ticks, the dropping earphone 10a, 10b may, for example, deliberately fail to increment its system clock upon receipt of one or more clock signals from the oscillator circuit 111. The dropping earphone 10a, 10b may, in various embodiments, drop all necessary clock ticks at once, or may spread the ticks to be dropped over a larger period. This may make the dropped ticks less audibly perceptible to the listener. Also, in some embodiments, the drift between the respective system clocks may be calculated as a rate of drift. The dropping earphone 10a, 10b may be configured to periodically drop ticks based on the calculated rate of drift. The rate of drift may be updated (e.g., upon the exchange of a new edge event).

The edge events described herein may be communicated between the earphones 10a, 10b in any suitable manner (e.g., via communications link 15, via an out-of-band channel, etc.). For example, the master 10a may communicate the edge events in a broadcast and/or multicast manner according to any suitable protocol such as User Datagram Protocol (UDP). Any suitable Internet Protocol (IP) address may be used for the multicast including, for example, IP addresses set aside specifically for multicast. According to various embodiments, communications from the slave 10b to the master 10a may be handled according to a separate multicast channel (e.g., utilizing a different multicast address or according to a different protocol). Both channels (e.g., slave 10b to master 10a and master 10a to slave 10b) may generally be considered part of the communication link 15.

The earphones 10a, 10b may also timestamp the various edge events in any suitable manner. In some embodiments, edge events may be time-stamped by the RF module 110 as this module may be the last component of the earphones 10a, 10b to process the edge event before it is transmitted sent from master 10a to slave 10b and the first to process the edge event as it is received at the slave 10a. For example, the RF module 110 may comprise hardware and/or software that may execute on the master 10a to timestamp edge events (e.g., at steps 402 and 408) before the respective edge events are transmitted to the slave 10b. Time-stamping may involve capturing a current value of the master's system clock and appending an indication of the current value to the edge event before it is transmitted (and or storing the current clock value locally as described). On the receiving end, the RF module 110 of the slave 10b may also be programmed to timestamp a received edge event. For example, the RF module 110 of the slave 10b may comprise hardware and/or software for capturing a current value of the slave's system clock upon receipt of the edge event and subsequently appending the captured value to the edge event for return to the master 10a. In various embodiments, the RF module 110 of the slave 10b may be configured, upon receipt of an edge event, to generate an interrupt to one or more components of the processor unit 114. The processor unit 114 may service the interrupt by capturing the current value of the slave's system clock and appending it to the edge event. In other embodiments, the RF module 110 of the slave 10b may be configured to capture a current value of the system clock itself upon receipt of the edge event from the master 10a. This may be desirable, for example, in embodiments using LINUX or another operating system that does not necessarily handle interrupts in a real-time manner.

Although the process flow 400 of FIG. 4 describes edge events originated by the master 10a, it will be appreciated that edge events may be originated by any suitable component including, for example, the source 12 or another non-earphone (or non-speaker) component. For example, in some embodiments, the source 12 or other suitable component may include a wireless beacon (e.g., Wi-Fi beacon) as a part of the transmitted digital audio signal. The beacon may include a timestamp based on the system clock of the originating source. The earphones 10a, 10b may be configured to assume that the propagation from the source 12 to each earphone 10a, 10b is the same and, therefore, may synchronize their own system clocks based on the timestamp of the received beacon. Also, in some embodiments, edge events transmitted between the earphones 10a, 10b may travel by way of an access point (not shown). Such edge events may be time stamped, for example, by the access point upon transmission, by the receiver upon receipt, etc.

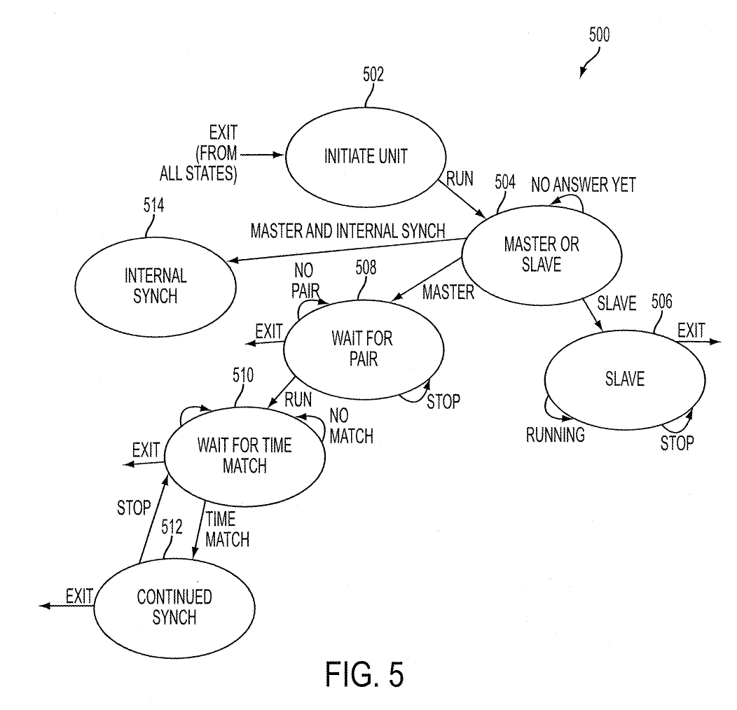

FIG. 5 is a state diagram showing an example state flow 500, according to various embodiments, for synchronizing the system clocks of the earphones 10a, 10b. The system flow 500 is described in the context of a single earphone 10, which may be a master 10a or slave 10b. In various embodiments, however, each earphone 10a, 10b may separately execute the state flow 500. At state 502, the earphone 10 may initiate, which may involve loading (e.g., to the volatile memory 120) various software modules for clock synchronization. Upon completion of initiation, the earphone 10 may transition to state 504, where the earphone 10 may determine whether it is configured as a master or a slave. Configuration data indicating the master/slave status of the earphone 10 may be stored, for example, at non-volatile memory 122 and, in some embodiments, may be loaded (e.g., to volatile memory 120 and/or one or more registers of the processor unit 114) during initiation. Until the earphone 10 determines whether it is a master or a slave, it may remain at state 504. If the earphone 10 determines that it is a slave, it may transition to the slave state 506, where the earphone 10 may receive and respond to edge events and drop system clock ticks as necessary, for example, as described by the process flow 400 above. In various embodiments, the earphone 10 may also respond to various other data requests in the slave state 506 including, for example, pairing inquiries.

Referring back to the state 504, if the earphone 10 determines that it is a master, it may transition to the state 508, where it may wait for an indication of its paired earphone (e.g., associated slave). For example, an indication of the paired earphone may also be stored at nonvolatile memory 122. In various embodiments, the indication of the paired earphone may be loaded to the volatile memory 120 and/or the processor unit 114 during the initiation state 502. Also, in some embodiments, the master earphone 10a may originate messages (e.g., broadcast and/or multicast) and await a response from its associated slave 10b. Communication between the master earphone 10a and slave earphone 10b during configuration (such as in state 508) may occur via the communication link 15 and/or via an out-of-band link. In various embodiments, receiving the indication of the paired earphone also comprises sending and/or receiving a confirmation message to the paired earphone to verify that it is present and operating (e.g., in the slave state 506). Until the indication of the paired earphone is received, the earphone 10 may remain in state 508. If a stop request is received (e.g., if a user of the earphone 10 turns it off, or otherwise indicates a stop, if the source 12 indicates a stop, etc.), then the earphone 10 may also remain in state 508.

When the indication of the paired earphone is received, the earphone 10 may transition to time match state 510. At time match state 510, the earphone 10 may initiate and/or receive edge events as described herein, for example, by process flow 400. Edge events may be generated (e.g., by the earphone 10) in a periodic manner, for example, every two (2) seconds, or some other suitable time period. Upon reaching a threshold level of synchronization, the earphone 10 may transition to the continued synchronization state 512. For example, the earphone 10 may transition to the continued synchronization state 512 upon the completion of a threshold number of edge event cycles and/or tick drops. In the continued synchronization state 512, the earphone 10 may continue to initiate and/or receive edge events. Edge events in the continued synchronization state 512, however, may be less frequent than in the time match state 510.

Various states in the state diagram 500 (e.g., 506, 508, 510, 512) include transitions entitled “exit.” These may occur, for example, at the completion of the playback of audio data, when indicated by a user of the earphone 10 or for any other suitable reason. Upon the occurrence of an exit transition, the earphone 10 may return to the initiate unit state 502. Also, an internal synchronization state 514 may be included in various embodiments where clock synchronization of the earphone 10 is not necessary. For example, the synchronization state 514 may be utilized in embodiments where the paired headphone has a direct, wired link to either the earphone 10 or both paired earphones have a direct, wired link to a common clock (e.g., clock synchronization is not necessary).

It will be appreciated that there are various other methods and systems for synchronizing remote system clocks, and that any suitable method may be used. For example, the IEEE 1588 protocol provides methods for synchronizing clocks between network devices.

Independent of clock synchronization, the earphones 10a, 10b may synchronize playback of the audio data. In various embodiments, the earphones 10a, 10b may both maintain checksums of some or all of digital units (e.g., frames, samples, bytes, other digital units, etc.) that are in a playback queue. The playback queue for each earphone 10a, 10b may include units that either are to be played or have recently been played (e.g., converted to sound by the transducer(s) 106). Units in the playback queue may be arranged chronologically in the order that they will, or being, or have been played. Although referred to herein as checksums, it will be appreciated that any suitable representation of the relevant audio data may be used including, for example, hashes, compressions, etc. The checksums may represent any suitable denomination of the audio data at any stage of the playback process, referred to herein as units. For example, in embodiments where the audio data is compressed according to a framed format, such as the MPEG 1 or 2, audio layer III format, each checksum may correspond to one frame or at least one sample sent to the decoder 305. Also, in some example embodiments, each checksum may correspond to a unit of decompressed audio 306 measured after the decoder 305, but prior to the DAC 125, for example, in PCM format.

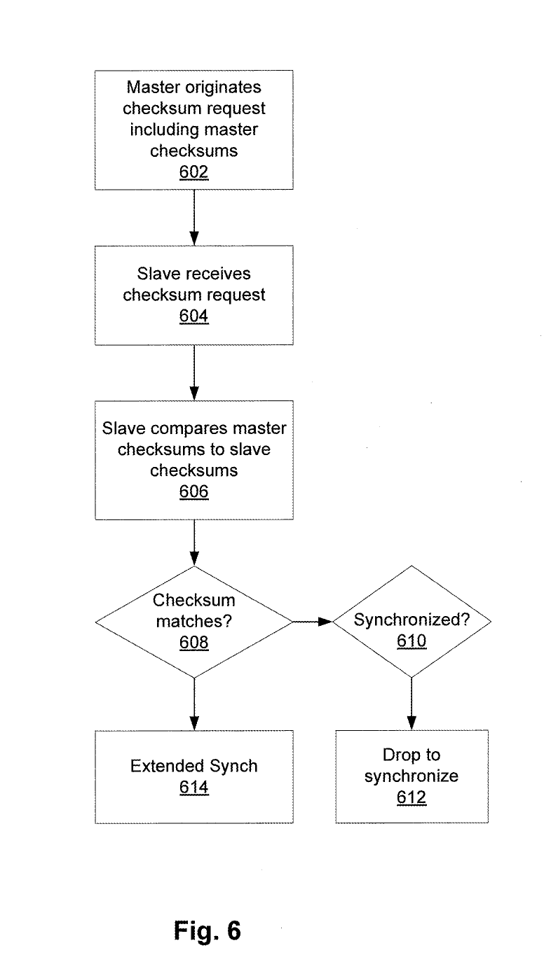

The checksums may be used by the earphones 10a, 10b to compare the portion of the audio data being played at any given time and to make corrections for synchronization. FIG. 6 is a flow chart showing an example process flow 600, according to various embodiments, for synchronizing audio data playback. The audio playback synchronization process may be managed by a master earphone 10a. The master earphone 10a may, but need not be, the same master earphone utilized for system clock synchronization described above.

At step 602, the master 10a may originate a checksum request to the slave 10b. The request may include a set of master checksums from the master 10a indicating a set of units from the master's playback queue (e.g., units that are playing, have recently been played or are queued to be played by the master 10a). In some embodiments, the request includes other information such as, for example, a header, timestamps, etc. Checksums in the master checksum set may be arranged and/or described chronologically. For example, the position of each checksum in the master checksum set may correspond to the position of the corresponding unit in the master's playback queue. The number of master checksums in the request may be determined according to any suitable criteria (e.g., the speed of the link 15). For example, in some embodiments, 48 checksums may be included, representing about 1.2 seconds of MPEG-2, audio-layer III (MP3) audio. The slave 10b may receive the checksum request at step 604.

At step 606, the slave 10b may compare the master checksums to its own set of slave checksums. The set of slave checksums may indicate a set of units from the slave's playback queue (e.g., also arranged chronologically). The master and slave checksum sets may indicate units from equivalent positions in the playback queues of the respective earphones 10a, 10b. If there are matches between the master checksums and the stored checksums of the slave (e.g., the slave checksums) it may indicate that the earphones 10a, 10b are either completely synchronized, or out of synchronization by an amount less than the audio time of the sum of the master checksums. In the case that there are matches at decision step 608, the slave 10b may determine whether the master 10a and slave 10b are synchronized. For example, if the matched checksums occur at the same position in the respective checksum sets, it may indicate synchronization. On the other hand, if the matched checksums occur at offset positions in the respective checksum sets, it may indicate a lack of synchronization. The absolute value of the offset may indicate the number of units of difference between the playback positions of the master 10a and slave 10b. The direction of the offset may indicate which earphone 10a, 10b is behind. For example, if equivalent checksum values appear earlier in one earphone's checksum set than they do in the other earphone's checksum set, it may indicate that the first earphone is behind.

If the earphones 10a, 10b are synchronized, the slave 10b may send the master 10a an indication of synchronization. In some example embodiments, the slave 10b may also send the master 10a the set of slave checksums, which may, for example, allow the master to verify synchronization. Also, in other embodiments, instead of determining synchronization itself, the slave 10b may send its set of slave checksums back to the master 10a which may, then, determine whether the earphones 10a, 10b are synchronized.

If the slave 10b and master 10a are not synchronized at 610, then the earphones 10a, 10b may drop units to synchronize at 612. For example, the slave 10b may determine which earphone 10a, 10b is behind, and by how many units. This may be determined by the offset between the matched checksums from 608. For example, if the master and slave sets of checksums match, but the match is offset by X checksums, it may indicate that one earphone 10a, 10b is behind the other by X units. The direction of the offset may indicate which earphone 10a, 10b is behind. If the slave 10b is behind, it may drop the appropriate number of units. If the master 10a is behind, the slave 10b may send the master 10a an instruction to drop the appropriate number of units. In some embodiments, the instruction may include the slave checksum set, allowing the master 10a to verify the calculation of the slave 10b. Also, in some embodiments, the slave 10b may not determine which earphone 10a, 10b is behind and may instead send its slave checksums to the master 10a, which may determine which earphone 10a, 10b is behind and instruct it to drop units. Units may be dropped all at once, or may be spread out over time so as to minimize distortion of the playback. If there are no checksum matches at 608, it may indicate that the earphones 10a, 10b are out of synchronization by an amount of time greater than the playtime of the set of checksums. To remedy this, the earphones 10a, 10b may enter an extended synchronization mode at 614. In some example embodiments, dropping may occur only when the offset between the earphones 10a, 10b is greater than a threshold number of units.

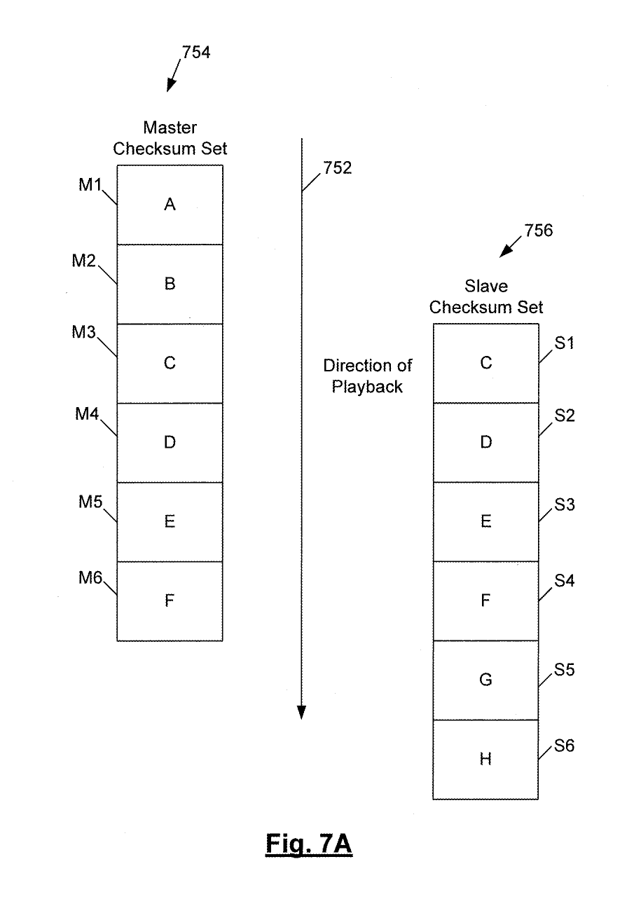

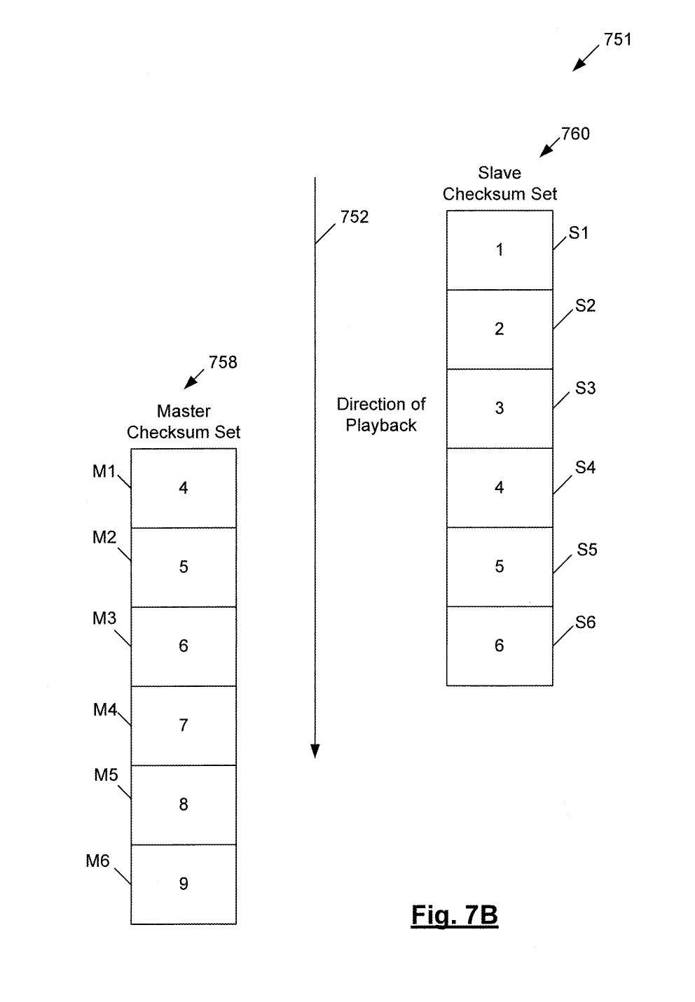

FIGS. 7A and 7B are block diagrams 750, 751 showing comparisons between example master checksum sets and example slave checksum sets, according to various embodiments. In both of the block diagrams, the checksum sets comprise six checksums, indicated by M1, M2, M3, M4, M5, M6 for the master checksum sets and S1, S2, S3, S4, S5, S6 for the slave checksum sets. Any suitable number of checksums, however, may be included in the checksum sets. A direction of playback arrow 752 indicates an orientation of the checksums from first played (or to be played) to last. In some embodiments, each checksum may be associated with a time indicating when the corresponding unit is to be played.

In the example diagram 750 of FIG. 7A, the there is an offset match between the values of the master checksum set 754 and the values of the slave checksum set 756. As illustrated, the amount of the offset is two units, with the slave 10b ahead, as the match begins with the S1 checksum corresponding to the M3 checksum. This indicates that the slave 10b is further ahead in the playback than the master 10a. In the example illustrated by the diagram 750, the master 10a may “catch-up” by dropping two units instead of playing them, for example, as described above with respect to 612. The dropped units may be any units in the playback queue of the master 10a that have not yet been played. In the example chart 751, there is an offset match between the values of the master checksum set 758 and the slave checksum set 760. As illustrated, the amount of the offset is three with the master 10a ahead, as the match begins with the M1 checksum matching the S4 checksum. This indicates that the master 10a is further ahead in the playback than the slave 10b. In the example illustrated by the diagram 751, the slave may “catch-up” by dropping three units, for example, as described above with respect to 612.

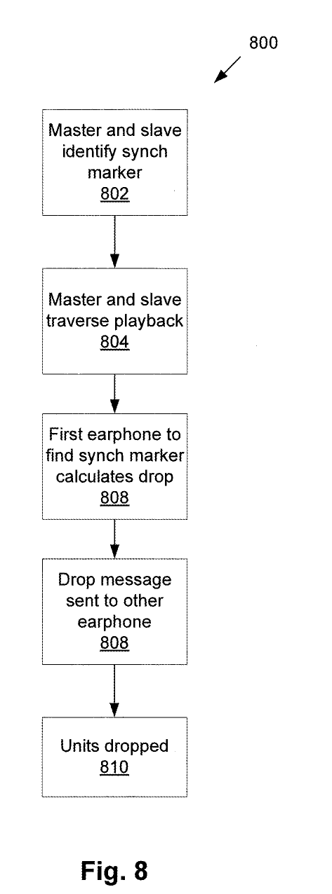

FIG. 8 is a flow chart showing an example process flow, according to various embodiments, for implementing the extended synchronization mode 614. At the outset of the extended synchronization mode 614, the slave 10b may have received the master checksum set and provided its slave checksum set to the master 10a. Upon determining that there are no matches between the master and slave checksum sets (at 608), the earphones 10a, 10b may enter the extended synchronization mode. In some embodiments, the earphones 10a, 10b may not enter extended synchronization mode based on a single failure to match checksum sets but may instead enter extended synchronization mode only upon a predetermined number of failures to match checksum sets (e.g., consecutive failures). In some embodiments, each earphone 10a, 10b may independently determine whether to enter the extended synchronization mode, while in other embodiments, one earphone (e.g., master 10a or slave 10b) may determine to enter the extended synchronization mode and instruct the other accordingly. Because there was no match between the master and slave checksum sets, neither earphone 10a, 10b may know, at the outset of synchronization mode 614, the value or the direction of the playback offset between the earphones 10a, 10b.

Once the earphones 10a, 10b are in extended synchronization mode 614, each earphone 10a, 10b may identify a synchronization marker for the other earphone 10a, 10b. The synchronization marker for each earphone 10a, 10b may be an indication of the earphone's position in the playback. For example, the synchronization marker for each earphone 10a, 10b may be a subset of checksums from a predetermined position in the earphone's checksum set corresponding to a unit or set of units in the playback. The predetermined position may indicate a unit or units being currently played, a unit or units just played, a unit or units about to be played, etc. The subset of checksums may comprise a single checksum, or multiple checksums.

At 804, the master 10a and slave 10b may traverse the playback (e.g., the common audio playback signal), comparing the playback to the synchronization marker of the opposite earphone 10a, 10b. While traversing the playback, the earphones 10a, 10b may continue to play the playback out of synchronization, or may stop playing the playback (e.g., stop converting it to sound at the transducer(s) 106) until synchronization is achieved. At 806, one of the earphones 10a, 10b may encounter the other earphone's synchronization marker in the playback. In various embodiments, the finding earphone is behind. For example, as the finding earphone finds the other earphone's synchronization marker it may just be reaching the point in the playback where the other earphone was when generating its checksum set. The finding earphone may know its current position in the playback and the time at which the opposite earphone was at the same position in the playback (e.g., the time that the synchronization marker was set, or the time that the checksum set from the opposite earphone was sent). From this, the finding earphone may determine the number of units that it is behind. At 808, the finding earphone may send the opposite earphone a message indicating that the finding earphone has found the other's synchronization marker. In some embodiments, the message may also indicate the number of units to be dropped. When the opposite earphone receives the message, it may cease its own search for the finding earphone's synchronization marker. At 810, the finding earphone may drop the determined number of units, bringing the earphones 10a, 10b into synchronization on the playback. In some embodiments, as described herein below, the finding earphone may wait to receive an acknowledgement from the opposite earphone before beginning to drop units.

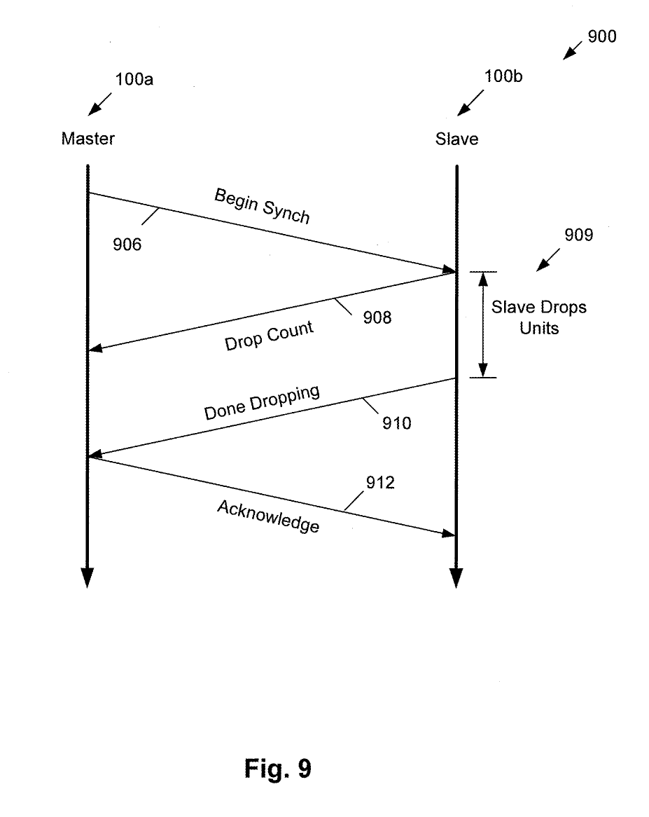

FIGS. 9-14 are bounce diagrams showing synchronization of the earphones 10a, 10b (e.g., according to the process flows 600, 800 described above). Each of the bounce diagrams of FIGS. 9-14 may represent a different starting point and/or processing result. FIG. 9 is a bounce diagram 900 showing synchronization of the earphones 10a, 10b in an example situation where the slave 10b is behind the master 10a, but by a number of units small enough to avoid the extended synchronization mode. Accordingly, in the example situation of FIG. 9, there may be an offset match between the master checksum set and the slave checksum set. In the bounce diagram 900, timeline 100a indicates actions of the master earphone 10a. Timeline 100b indicates actions of the slave earphone 10b. At 906, the master 10a may initiate the synchronization by sending a begin-synchronization message to the slave 10b. The begin-synchronization message may include a current set of master checksums. The slave 10b may receive the set of master checksums and compare it to the slave's own slave checksum set. In the example situation of FIG. 9, the slave 10b determines that it is behind (e.g., there is a match between the master and slave checksums, but the match is offset). In response, the slave 10b may send a drop-count message 908 to the master 10a and begin dropping units at 909. The drop-count message 908 may indicate to the master 10a that the slave 10b has determined it is behind and begun dropping units. The drop-count message 908 may also include an indication of the number of units to be dropped and, in some cases, the set of slave checksums. The number of units to be dropped may be, for example, the amount of the offset between matches. When the slave has completed dropping units at 909, it may send a done-dropping message 910 to the master 10a. The done-dropping message 910 may indicate that the slave 10b has completed its unit drop. The master 10a may send the slave 10b an acknowledge message at 912.

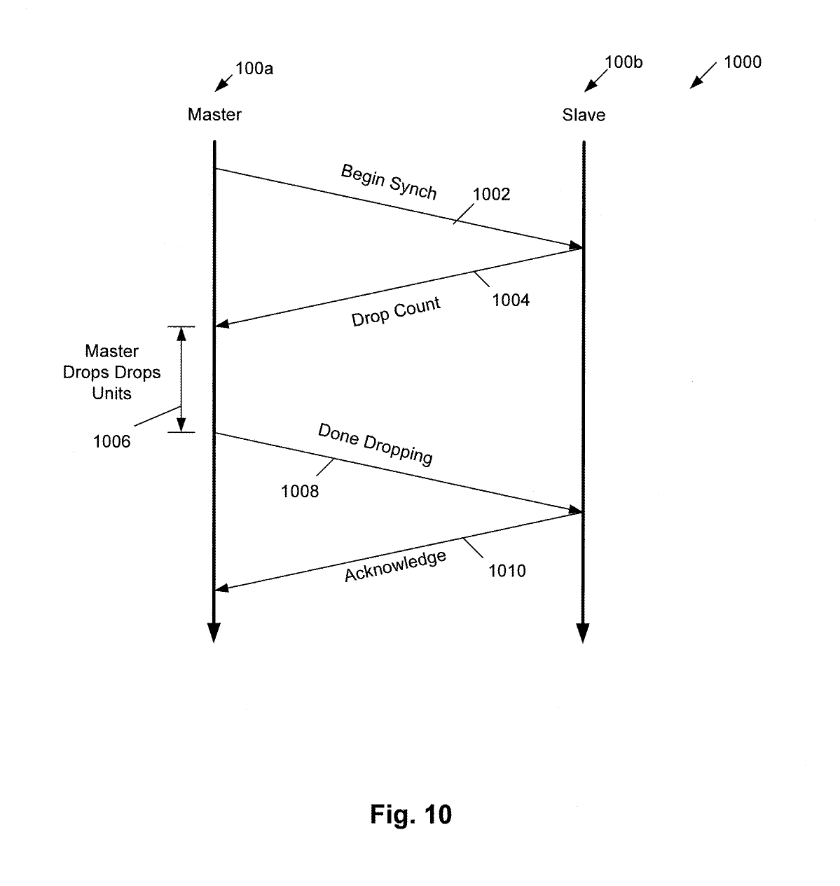

FIG. 10 is a bounce diagram 1000 showing synchronization of the earphones 10a, 10b in an example situation where the master 10a is behind the slave 10b, but by a number of units small enough to avoid the extended synchronization mode. The master 10a may send a begin-synchronization message 1002 to the slave 10b including the master checksum set. Upon receipt of the begin-synchronization message 1002, the slave 10b may, in this example, determine that there is an offset match between master checksum set and the slave checksum set, and that the master 10a is behind. The slave 10b may send a drop-count message 1004 to the master 10a. The drop-count message 1004, in this example, may indicate that the master 10a is ahead and a number of units by which the master 10a is ahead (e.g., the amount of the offset between matched units in the checksum sets). At 1006, the master 10a may drop units until it is synchronized. After completing the dropping, the master 10a may send the slave 10b a done-dropping message 1008. The slave 10b may acknowledge the done-dropping message 1008 with an acknowledge message 1010.

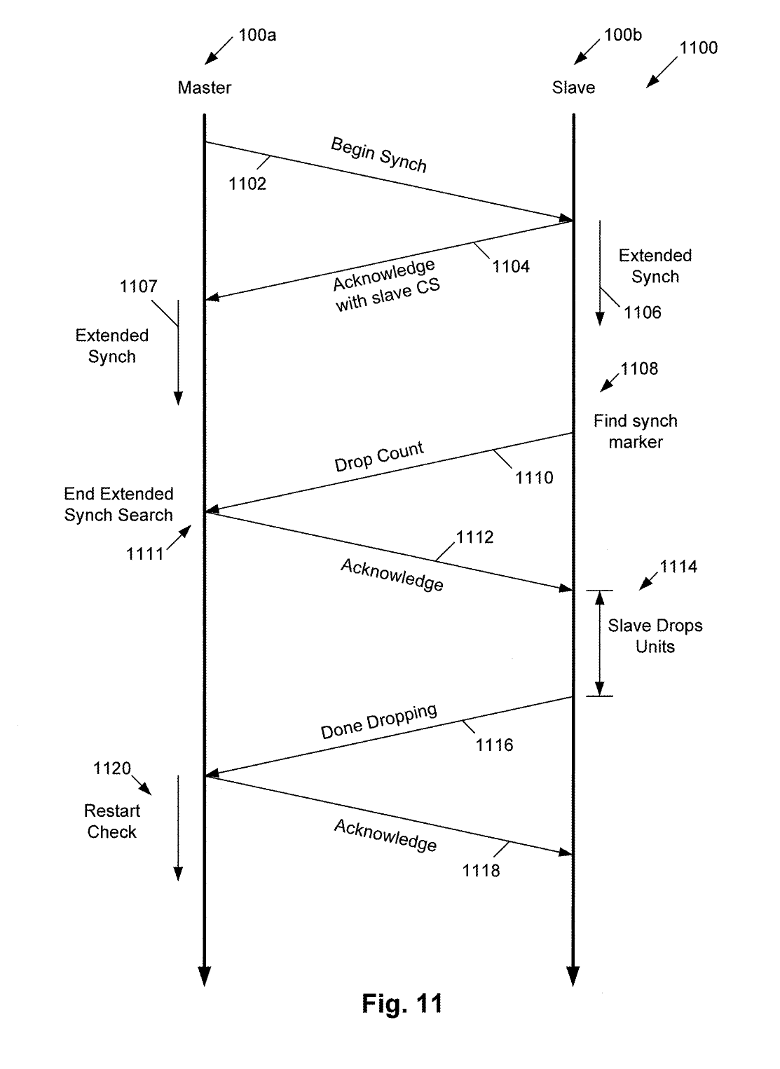

FIG. 11 is a bounce diagram 1100 showing synchronization of the earphones 10a, 10b in an example situation where the slave 10b is behind by a number of units large enough to implicate the extended synchronization mode. In the example shown in FIG. 11, the slave is behind and drops units. Similar to the bounce diagrams 900 and 1000, the master 10a may initiate the synchronization with a begin-synchronization message 1102. The begin-synchronization message 1102 may include the master checksum set. The slave 10b may determine that there is no match between the master checksum set and its slave checksum set, leading to extended synchronization 614. Accordingly, the slave 10b may determine the master's synchronization marker and begin to traverse the playback in extended synchronization mode looking for the master's synchronization marker. The slave 10b may also send an acknowledge message 1104 with the slave's checksums to the master. The message 1104 may, in some cases, include an indication that the slave 10b has entered extended synchronization mode 614. The master 10a may also enter extended synchronization mode 614 at 1107, either based on its own comparison of the slave and master checksum sets or based on a command or other indication received from the slave 10b.

In the example illustrated by the diagram 1100, the slave 10b is behind. Accordingly, the slave 10b may find the master's synchronization marker at 1108. At this point, the slave 10b may be at the same or a similar position in the playback as the master 10a was when it sent the master checksum set. Accordingly, the slave 10b may calculate the number of units that it will have to drop to catch up with the master 10a. Upon finding the master's synchronization marker and calculating a number of units to drop, the slave 10b may send a drop-count message 1110 to the master. The message 1110 may indicate to the master 10a that the slave 10b has found the master's synchronization marker and, in some cases, may indicate the number of units that the slave 10b will drop. The master may respond with an acknowledge message 1112.

Upon receipt of the message 1112 (and, in some embodiments, before the receipt of the message 112), the slave 10b may drop the determined number of units at 1114. When the slave 10b has completed dropping, it may send a done-dropping message 1116 to the master 10a and exit extended synchronization. The master 10a may reply with an acknowledge message 1118. In some embodiments, the master may also restart the synchronization checking process at 1120. This may involve, for example, re-executing the process flow 600 immediately or after a delay. The duration of the delay may be predetermined.

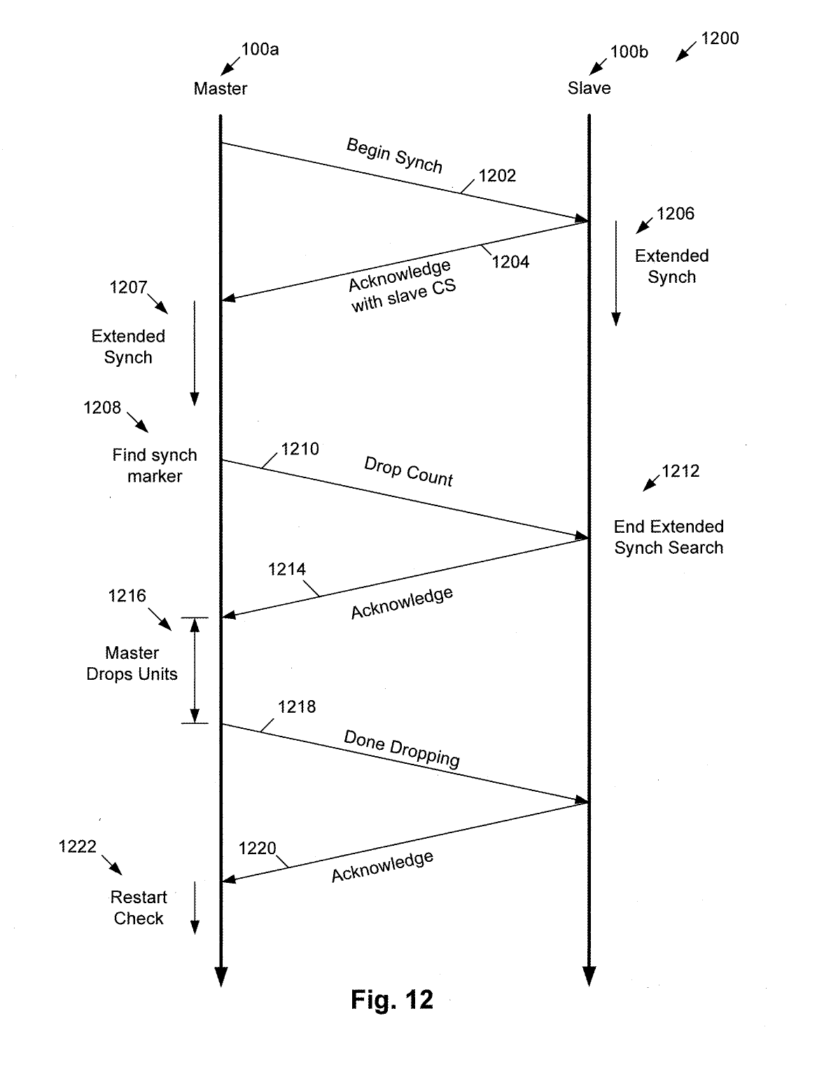

FIG. 12 is a bounce diagram 1200 showing synchronization of the earphones 10a, 10b in an example situation where the master 10a is behind by a number of units large enough to implicate the extended synchronization mode. In the example shown in FIG. 12, the master 10a is behind in the playback. The master 10a may initiate synchronization with a begin-synchronization message 1202 including the master checksum set. At 1206, the slave 10b may determine that there are no matches between the master and slave checksum sets, and enter the extended synchronization mode at 1206. The slave 10b may also send an acknowledgement message 1204 to the master 10a. As described above, the acknowledge message 1204 may include the slave's checksum set and/or an indication to enter the extended synchronization mode. The master 10a may enter the extended synchronization mode at 1207.

Because the master 10a is behind in the example shown in FIG. 12, it may find the slave's synchronization marker at 1208. Based on the slave's synchronization marker, the time that the slave 10b sent its slave checksums, and the master's current time (measured by its system clock), the master 10a may determine a number of units that it will drop. The master 10a may send a drop-count message 1210 to the slave 10b. The drop-count message 1210 may indicate to the slave 10b that it may stop looking for the master's synchronization marker and, in some embodiments, may also indicate the number of units that the master 10a will drop. The slave 10b may send an acknowledge message at 1214. Upon (or sometimes before) receipt of the acknowledge message 1214, the master 10a may drop the determined number of units at 1216. Upon completion of the drop, the master 1218 may send a done-dropping message 1218 to the slave 10b and exit extended synchronization. The slave 10b may reply with an acknowledge message 1220. Upon receipt of the acknowledge message 1220, the master 10a may restart the synchronization check process, as described above, at 1222.

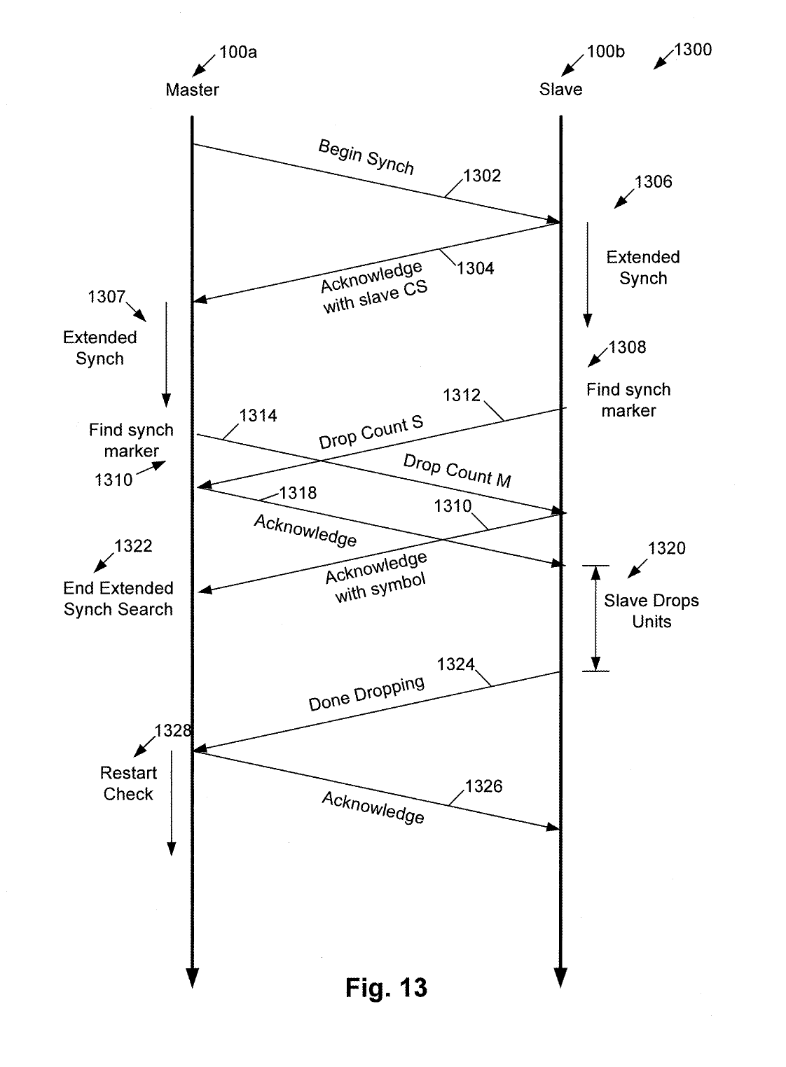

As illustrated by the bounce diagrams of FIGS. 9-12, there can be a delay between the sending of a message by one earphone 10a, 10b and receipt of the same message by the other earphone 10a, 10b. In some cases, the delay may allow both earphones 10a, 10b to believe that they are the first to find the other's synchronization marker. For example, FIG. 13 is a bounce diagram 1300 showing synchronization of the earphones 10a, 10b in an example embodiment where the slave 10a is behind by a number of units large enough to implicate the extended synchronization mode, but where both earphones 10a, 10b find the other's synchronization marker. As described above, the master 10a may initiate the synchronization process by sending a begin-synchronization message 1302 to the slave 10b. The begin-synchronization message 1302 may include the master checksum set. In the example illustrated in FIG. 13, the slave 10b may be behind the master 10a by an amount sufficient to require the extended synchronization mode 614. Accordingly, the slave 10b may not find any matches between the master checksum set and the slave checksum set. The slave 10b may enter the extended synchronization mode at 1306, and may send an acknowledge message 1304 (e.g., with the slave checksum set). Upon receipt of the acknowledge message 1304, the master 10a may enter extended synchronization mode at 1307.

At 1308, the slave 10b may be the first to find the other earphone's (in this case, the master's) synchronization marker in the playback. The slave 10b may send a slave drop-count message 1312 to the master 10a indicating that the slave 10b has found the master's synchronization marker (e.g., and a number of units to be dropped by the slave 10b). Before the message 1312 reaches the master 10a, however, the master 10a may find the slave's synchronization marker at 1310 and send the slave 10b a master drop-count message 1314. When the slave 10b receives the master drop-count message 1314, it may determine which earphone 10a, 10b found the other's synchronization marker first. For example, the slave 10b may compare the number of units that it should drop with a number of units that the master 10a believes it should drop (e.g., as included in the drop-count message 1314). The earphone 10a or 10b requiring the most unit drops may be the one that is actually behind (and the earphone that found the other's synchronization marker first). In some embodiments, each earphone may create a timestamp when finding a synchronization marker. When both headphones find a synchronization marker, the headphones 10a, 10b may compare the respective timestamps to determine which headphone found the other's synchronization marker first.

In the example of FIG. 13, this the slave 10b has found the master 10a synchronization marker first. Accordingly the slave 10b may acknowledge the master drop-count message 1314 with an acknowledgement message 1316. The message 1316 may comprise a symbol or other indication to the master 10a that the slave will drop units. At 1320, the slave 10b may drop units. Upon completion of the unit drop, the slave 10b may send a done-dropping message 1324 to the master 10a. The master 10a may acknowledge 1326 and may restart the synchronization checking process, as described above, at 1328. In various embodiments, the master 10a, upon receipt of the slave drop-count message 1312, may independently determine which earphone 10a, 10b is ahead. In the example shown by FIG. 13, the master 10a, upon determining that the slave is behind, may await the slave's acknowledgement 1316.

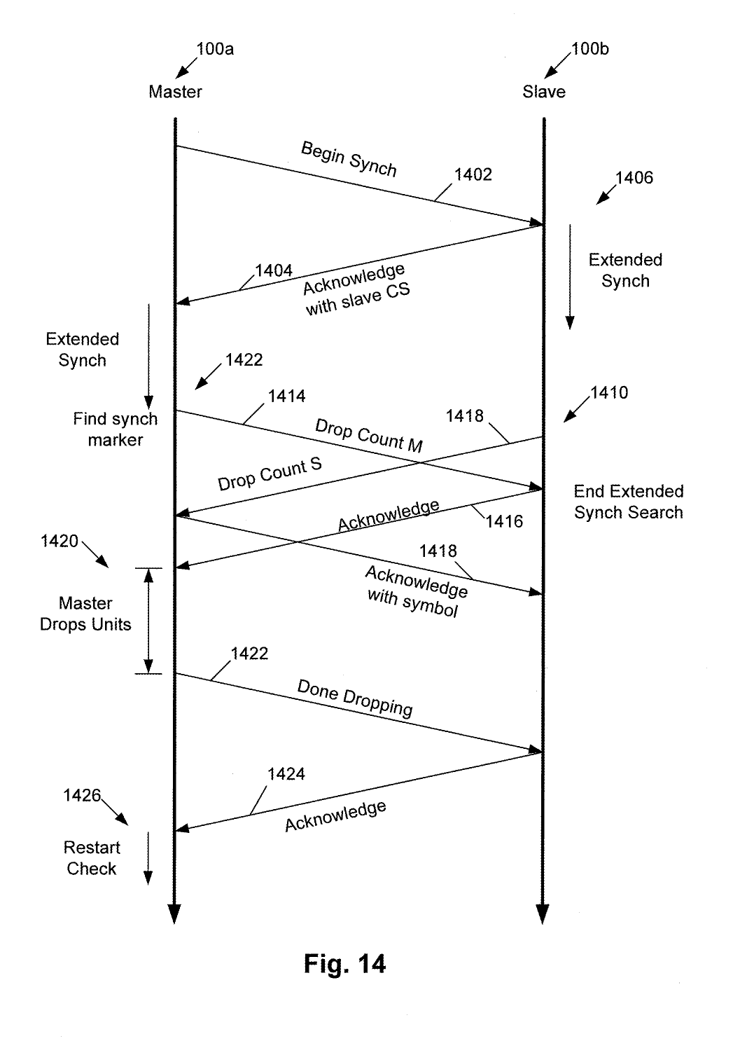

FIG. 14 is a bounce diagram 1400 showing synchronization of the earphones 10a, 10b in an example embodiment where the master 10a is behind by a number of units large enough to implicate the extended synchronization mode, but where both earphones 10a, 10b find the other's synchronization marker. The synchronization may begin when the master 10a sends a begin-synchronization message 1402 to the slave 10b (e.g., including the master checksum set). The slave 10b, upon finding no match between the master checksum set and its slave checksum set, may enter the extended synchronization mode at 1406, and may send an acknowledgement message 1404, optionally including the slave checksum set. Upon receipt of the acknowledgement message 1404, the master 10a may enter the extended synchronization mode at 1407. At 1408, the master 10a, which is behind in this example, may find the synchronization marker of the slave 10b and send a master drop-count message 1412 to the slave 10b, optionally including the number of units that the master 10a intends to drop.

Before receiving the master drop-count message 1412, the slave 10b may find the synchronization marker of the master 10a at 1410, and send its own slave drop-count message 1414. Upon receipt of the slave drop-count message 1414, the master 10a may determine which earphone 10a, 10b is behind. Upon determining that the master 10a is behind, the master 10a may send an acknowledgement message 1418 with a symbol, or other indication to the slave 10b that it should not drop units. Upon receiving the master drop-count message 1412, the slave 10b may examine which earphone 10a, 10b, is actually behind. Upon determining that the master 10a is behind (per the instant example) the slave 10b may send an acknowledge message 1416. Upon receipt of the acknowledge message 1416, the master may begin dropping units at 1420. When the unit drop is complete, the master 10a may send a done-dropping message 1422 to the slave. The slave may reply with an acknowledge message 1424. Upon receiving the acknowledge message 1424, the master 10a may restart the synchronization check, as described above.

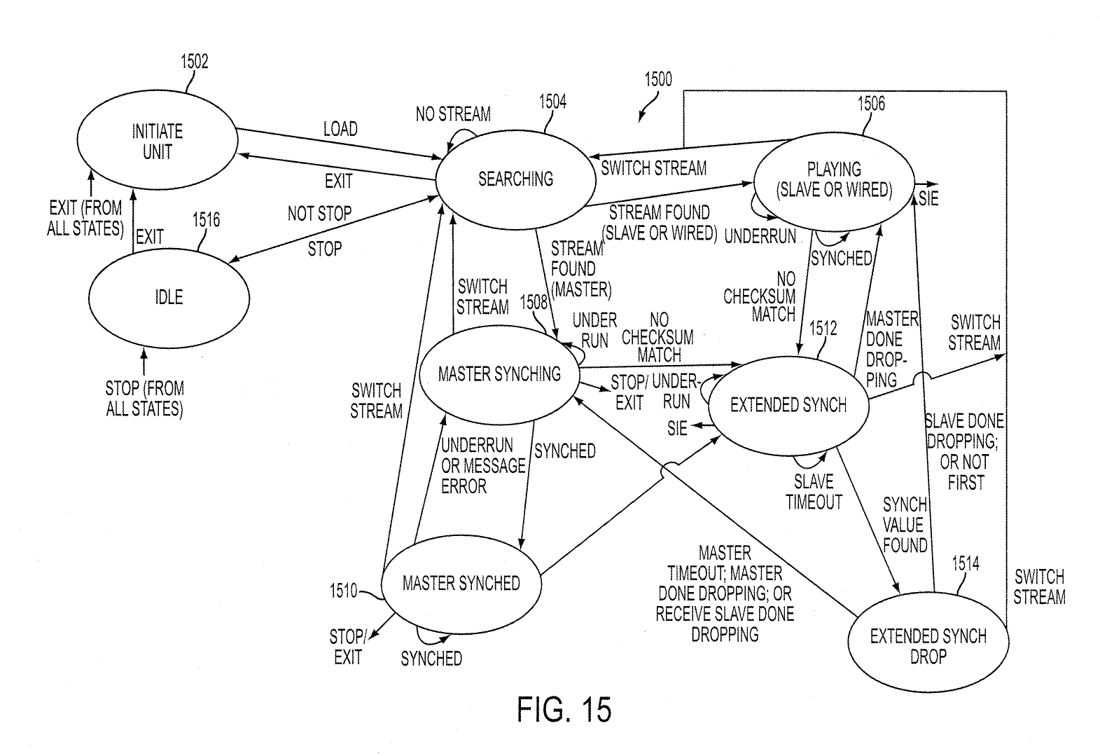

FIG. 15 is a state diagram showing an example state flow 1500, according to various embodiments, for synchronizing a playback (e.g., according to the process flows 600, 800 and incorporating concepts from the example bounce diagrams of FIGS. 9-14). Like the state flow 500 of FIG. 5 described above, the state flow 1500 is described in the context of a single earphone, which may be a master 10a or slave 10b. In various embodiments, each earphone 10a, 10b may separately execute the state flow 1500. Also, in various example embodiments, the state flow 1500 may be executed concurrently with (or sequentially to) the state flow 500. At 1502, the earphone 10 may initiate. Initiation may involve loading (e.g., to the volatile memory 120) various software modules and/or values for playback synchronization. For example, data indicating whether the earphone 10 is a slave or a master may be loaded. Upon completion of initiation, the earphone 10 may transition to searching state 1504. At searching state 1504, the earphone 10 may search for a playback stream (or other data format) to play. If the earphone 10 is a slave (or a wired earphone not requiring playback synchronization) it may transition to a playing state 1506 upon finding the stream. If the earphone 10 is a master, it may transition to a master synching state 1508 upon finding the stream. From the master synching state 1506, the earphone 10 may initiate a playback synchronization process, for example, as described above with respect to process flows 600, 800. Instructions may be sent to one or more slave earphones which, for example, may be in the playing state 1506. The synchronization process may proceed between the master earphone in the master synching state 1508 and one or more slave earphones 10b in the playing state 1506, for example, as described in process flow 600.

Upon synchronization, the earphone 10 (if it is a slave) may remain in the playing state 1506. If the earphone is a master, it may transition, upon synchronization, from the master synchronization state 1508 to a master synched state 1510. In the master synched state 1510, the master earphone may initiate synchronization (e.g., according to the process flows 600, 800) at a predetermined interval (e.g., every 2 seconds). The predetermined interval may be variable, for example, based on the degree to which the master and other earphones fall out of synchronization. For example, the more often the earphones are in, or close to being in synchronization with one another, the longer the interval may become.

The extended synchronization state 1512 and extended synchronization drop state 1514 may be used to implement extended synchronization, for example, as described herein above. A master earphone may enter the extended synchronization state 1512 from either the master synching state 1508 or the master synched state 1510, if there is no match between the master and slave checksum sets. A slave earphone may enter the extended synchronization state 1512 from the playing state 1506, for example, if there is no match between the master and slave checksum sets. The earphone (slave or master) may remain in the extended synchronization state 1512 until it finds the other earphone's synchronization marker or receives word that the other earphone has found its synchronization marker, at which point the earphones may transition to synchronization drop state 1514. The earphone may transition out of the extended synchronization drop state 1514 upon either completing its own dropping or receiving an indication that the other earphone has completed its dropping. A master may transition out of the extended synchronization drop state 1514 to master synching state 1508, as shown, or to master synched 1510. A slave may transition out of the extended synchronization drop state 1514 back to playing state 1506.

In various example embodiments, there may be common and/or similar transitions between states. For example, if the stream is lost, or if an instruction to switch streams is received, the earphone 10 may transition to the searching state 1504. Also, upon receipt of an exit command, the earphone 10 may transition to the initiate unit state 1502. Upon receipt of a stop command, the earphone 10 may transition to an idle state 1516. In the idle state 1516, the earphone 10 may cease playback. From the idle state, the earphone 10a may transition to the initiate unit state 1502 (e.g., if an exit command is received) or to the searching state 1504 (e.g., if a non-stop command is received). Commands for transitioning between states may be received from any suitable source. For example, a user may provide instructions either directly to the earphone 10, or to the source 12.

It will be appreciated that, in some cases, the earphone 10 in the state flow 1500 may experience underrun. Underrun may occur when the playback is received at a rate slower than the playback rate. When the earphone 10 experiences underrun, it may transition to and/or remain at its current state. For example, an earphone 10 in any of states 1508, 1506, 1512 may remain in that state upon occurrence of an underrun. In some embodiments, a master earphone in the master synched state 1510 may transition to the master synching state 1508 upon occurrence of an underrun.

Communication between the earphones 10a, 10b (e.g., link 15) may configured according to any suitable protocol including, for example, UDP. In some embodiments, communications between the earphones 10a, 10b, (e.g., as described in the process flows 400, 600, 800 and bounce diagrams 900, 1000, 1100, 1200, 1300, 1400, may take the form of UDP packets. Besides UDP, any suitable low overhead protocol can be used. For example, in another embodiment, instead of transmitting UDP packets to the slave earphone 10b, the earphones 10 may exchange ping messages, such as Internet Control Message Protocol (ICMP) messages. The ICMP messages may be, for example, “Echo request” and “Echo reply” messages. For example, the sending earphone (master or slave, depending on the circumstance) may transmit an “Echo request” ICMP message and the receiving earphone may in return transmit an “Echo reply” ICMP message to the master earphone 10a.

The examples presented herein are intended to illustrate potential and specific implementations of the embodiments. It can be appreciated that the examples are intended primarily for purposes of illustration for those skilled in the art. No particular aspect or aspects of the examples is/are intended to limit the scope of the described embodiments. The figures and descriptions of the embodiments have been simplified to illustrate elements that are relevant for a clear understanding of the embodiments, while eliminating, for purposes of clarity, other elements.

In various embodiments disclosed herein, a single component may be replaced by multiple components and multiple components may be replaced by a single component to perform a given function or functions. Except where such substitution would not be operative, such substitution is within the intended scope of the embodiments.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. An apparatus comprising:
a first acoustic speaker device comprising a first acoustic transducer and a first transceiver, wherein the first transceiver receives and transmits wireless signals; and
a second acoustic speaker device comprising a second acoustic transducer and a second transceiver, wherein the second transceiver receives and transmits wireless signals, wherein the first and second speaker devices communicate wirelessly, wherein the first and second acoustic speaker devices play a common audio playback signal received from a source, and wherein:
the first acoustic speaker device transmits wirelessly a first message comprising a first checksum set, the first checksum set comprising a plurality of checksums indicating units of the common audio playback signal in a playback queue of the first acoustic speaker device;
the second acoustic speaker device receives the first message and compares the first checksum set to a second checksum set, wherein the second checksum set comprises a plurality of checksums indicating units of the common audio playback signal in a playback queue of the second acoustic speaker device; and
conditioned upon a match existing between at least one of the plurality of checksums of the first checksum set and at least one of the plurality of checksums of the second checksum set, at least one of the first and second acoustic speaker devices determines an offset of the match, wherein an absolute value of the offset indicates a number of units between positions of the first and second acoustic speaker devices in the common playback audio signal and a direction of the offset indicates which of the first and second acoustic speaker devices is behind.

2. The apparatus of claim 1, wherein, conditioned upon the absolute value of the offset being greater than a threshold number of units, one of the first and second acoustic speaker devices drops a number of units of the common playback audio signal equal to the absolute value of the offset

3. The apparatus of claim 1, wherein the first checksum set and the second checksum set correspond to equivalent portions of the respective playback queues of the first and second acoustic speaker devices.

4. The apparatus of claim 1, wherein, conditioned upon no match existing between at least one of the plurality of checksums of the first checksum set and at least one of the plurality of checksums of the second checksum set,
the first acoustic speaker device compares units of the common playback audio signal subsequently received by the first acoustic speaker device to a subset of the second checksum set; and
the second acoustic speaker device compares units of the common playback audio signal subsequently received by the second acoustic speaker device to a subset of the first checksum set.

5. The apparatus of claim 4, wherein the subset of the second checksum set comprises a plurality of checksums.

6. The apparatus of claim 4, wherein comparing units of the common playback audio signal subsequently received by the first acoustic speaker device to the subset of the second checksum set comprises finding a checksum for each of the units of the common playback audio signal subsequently received by the first acoustic speaker device.

7. The apparatus of claim 4, wherein, upon finding a match between at least one of the units of the common playback audio signal subsequently received by the first acoustic speaker device and the subset of the second checksum set, the first acoustic speaker device calculates a number of units that the first acoustic speaker device is behind the second acoustic speaker device by comparing a position of the subset of the second checksum set within the common audio playback signal to a position within the common playback audio signal of the at least one of the units of the common playback audio signal matching the first checksum.

8. The apparatus of claim 7, wherein the position within the common playback audio signal is indicated by a time.

9. The apparatus of claim 7, wherein upon finding the match between at least one of the units of the common playback audio signal subsequently received by the first acoustic speaker device and the subset of the second checksum set:
the first acoustic speaker device sends a message to the second acoustic speaker device indicating the match; and
upon receiving an acknowledgement to the message, the first acoustic speaker device drops a number of units equal to the number of units that the first acoustic speaker device is behind the second acoustic speaker device.

10. The apparatus of claim 7, wherein upon finding the match between at least one of the units of the common playback audio signal subsequently received by the first acoustic speaker device and the subset of the second checksum set, the first acoustic speaker device:
sends a message to the second acoustic speaker device indicating the match; and
receives from the second acoustic speaker device a message indicating that, prior to the match, the second acoustic speaker device found a match between one of the units of the common playback audio signal subsequently received by the second acoustic speaker device and the subset of the first checksum set.

11. The apparatus of claim 1, wherein, upon finding a match between at least one of the units of the common playback audio signal subsequently received by the second acoustic speaker device and the subset of the first checksum set, the second acoustic speaker device calculates a number of units that the second acoustic speaker device is behind the first acoustic speaker device by comparing a position of the subset of the first checksum set within the common audio playback signal to a position within the common playback audio signal of the one of the units of the common playback audio signal matching the subset of the first checksum set.

12. The apparatus of claim 1, wherein the common audio playback signal is compressed according to a first compression format, and wherein the units of the common audio playback signal corresponding to the plurality of checksums of the first and second checksum sets are defined according to the first compression format.

13. The apparatus of claim 1, wherein the units of the common audio playback signal corresponding to the plurality of checksums of the first and second checksum sets correspond to at least one of frames of the common audio playback signal and samples of the common audio playback signal.

14. The apparatus of claim 1, wherein the units of the common audio playback signal correspond to frames of the common audio playback signal, and wherein each frame comprises a plurality of samples of the common audio playback signal.

15. A method executed by first and second acoustic speaker devices to synchronize playback of a common audio playback signal by the first and second acoustic speaker devices, the method comprising:
the first acoustic speaker device transmitting wirelessly a first message comprising a first checksum set, the first checksum set comprising a plurality of checksums indicating units of the common audio playback signal in a playback queue of the first acoustic speaker device, wherein the first acoustic speaker device comprises a first acoustic transducer and a first transceiver for receiving ant transmitting wireless signals;
the second acoustic speaker device receiving the first message and comparing the first checksum set to a second checksum set, wherein the second checksum set comprises a plurality of checksums indicating units of the common audio playback signal in a playback queue of the second acoustic speaker device, and wherein the second acoustic speaker device comprises a second acoustic transducer and a second transceiver for receiving ant transmitting wireless signals; and
conditioned upon a match existing between at least one of the plurality of checksums of the first checksum set and at least one of the plurality of checksums of the second checksum set, at least one of the first and second acoustic speaker devices determining an offset of the match, wherein an absolute value of the offset indicates a number of units between positions of the first and second acoustic speaker devices in the common playback audio signal and a direction of the offset indicates which of the first and second acoustic speaker devices is behind.

16. The method of claim 15, further comprising, conditioned up on the absolute value of the offset being greater than a threshold, one of the first and second acoustic speaker devices dropping a number of units of the common playback audio signal equal to the absolute value of the offset

17. The method of claim 15, wherein the first checksum set and the second checksum set correspond to equivalent portions of the respective playback queues of the first and second acoustic speaker devices.

18. The method of claim 15, further comprising, conditioned upon no match existing between at least one of the plurality of checksums of the first checksum set and at least one of the plurality of checksums of the second checksum set,
the first acoustic speaker device comparing units of the common playback audio signal subsequently received by the first acoustic speaker device to a subset of the second checksum set;
the second acoustic speaker device comparing units of the common playback audio signal subsequently received by the second acoustic speaker device to a subset of the first checksum set.

19. The method of claim 18, wherein the subset of the second checksum set comprises a plurality of checksums.

20. The method of claim 15, further comprising, upon the first acoustic speaker device finding a match between at least one of the units of the common playback audio signal subsequently received by the first acoustic speaker device and the subset of the second checksum set, the first acoustic speaker device calculating a number of units that the first acoustic speaker device is behind the second acoustic speaker device by comparing a position of the subset of the second checksum set within the common playback audio signal to a position within the common playback audio signal of the at least one of the units of the common playback audio signal matching the first checksum.

21. The method of claim 20, further comprising, upon finding the match between one of the units of the common playback audio signal subsequently received by the first acoustic speaker device and the subset of the second checksum set:
the first acoustic speaker device sending a message to the second acoustic speaker device indicating the match; and
upon receiving an acknowledgement to the message, the first acoustic speaker device dropping a number of units equal to the number of units that the first acoustic speaker device is behind the second acoustic speaker device.

22. The method of claim 20, further comprising, upon finding the match between one of the units of the common playback audio signal subsequently received by the first acoustic speaker device and the subset of the first checksum set, the first acoustic speaker device:
sending a message to the second acoustic speaker device indicating the match; and
receiving from the second acoustic speaker device a message indicating that, prior to the match, the second acoustic speaker device found a match between one of the units of the common playback audio signal subsequently received by the second acoustic speaker device and the second checksum.

23. The method of claim 15, further comprising, upon finding a match between one of the units of the common playback audio signal subsequently received by the second acoustic speaker device and the subset of the first checksum set, the second acoustic speaker device calculating a number of units that the second acoustic speaker device is behind the first acoustic speaker device by comparing a position of the subset of the first checksum set within the common playback audio signal to a position within the common playback audio signal of the one of the units of the common playback audio signal matching the second checksum.

24. The method of claim 15, wherein the common audio playback signal is compressed according to a first compression format, and wherein the units of the common audio playback signal corresponding to the plurality of checksums of the first and second checksum sets are defined according to the first compression format.

25. The method of claim 15, wherein the units of the common audio playback signal corresponding to the plurality of checksums of the first and second checksum sets correspond to at least one of frames of the common audio playback signal and samples of the common audio playback signal.

26. The method of claim 25, wherein the units of the common audio playback signal correspond to frames of the common audio playback signal, and wherein each frame comprises a plurality of samples of the common audio playback signal.
